(19) United States
(12) Patent Application Publication
(10) Pub. No.: US 2016/0063589 A1
(43) Pub. Date: Mar. 3, 2016

(54) APPARATUS AND METHOD FOR SMART PHOTOGRAPHY

(71) Applicant: Shelly Xu, New York, NY (US)

(72) Inventor: Shelly Xu, New York, NY (US)

(21) Appl. No.: 14/473,570

(22) Filed: Aug. 29, 2014

(51) Int. Cl. G06Q 30/06; H04N 5/222; G06T 11/60; H04N 5/265

(52) U.S. Cl. CPC G06Q 30/0623; H04N 5/265; H04N 5/222; G06T 11/60

(57) ABSTRACT

A method and a system for smart photography are disclosed. The system may include a retrieval module comprising one or more processors configured to determine a description of the item from the identity of the item. The system may include a sensor configured to capture an image including an image of the item. The system may include an image processing module comprising the one or more processors configured to identify the image of the item in the captured image using the description of the item and configured to generate from the captured image a generated image comprising the image of the item and an identification indicator of the image of the item. The image may be identified based on comparing the image with descriptions of other identified items. Optionally, the system may include an identification device configured to determine an identity of an item.

### TECHNICAL FIELD

The present application relates generally to the technical field of photography and, in one specific example, to identifying merchandise in a photograph in retail environments.

### BACKGROUND

Often people like to see how they look in clothes and accessories before buying the clothes. Conventional fitting rooms have been provided in this regard, but one challenge has been to prevent customers from intentionally or accidently forgetting to remove the clothing or pay for the clothing before leaving the store.

In some shops, simple photo booths are provided to take pictures of fitted merchandise, but here there is no provision for identifying items in a photograph, particularly where a photograph may include many items and where the items may be partially obscured.

Another challenge can be obtaining the identification of customers or potential customers that may try on clothes in a store for relevant marketing and promotional purpose. Another challenge is determining how desirable items for sale at a store are.

### BRIEF DESCRIPTION OF THE DRAWINGS

Some embodiments are illustrated by way of example and not limitation in the figures of the accompanying drawings in which:

FIG. 1 is a block diagram of a smart photography system according to an example embodiment;

FIG. 2 is an illustration of a smart photography system according to an example embodiment;

FIG. 3 illustrates an example interface for identifying the items according to an example embodiment;

FIG. 4 illustrates an example embodiment for a smart photography system according to an example embodiment;

FIG. 5 is an example of a generated image according to an example embodiment;

FIG. 6 illustrates an example interface for a user to enter a user identification according to an example embodiment;

FIG. 7 illustrates a method of a smart photography system according to an example embodiment; and

FIG. 8 is a block diagram of a machine or apparatus in the example form of a computer system according to an example embodiment.

### DETAILED DESCRIPTION

Example methods and systems for smart photography are described. In the following description, for purposes of explanation, numerous specific details are set forth in order to provide a thorough understanding of example embodiments. It will be evident, however, to one skilled in the art that example embodiments may be practiced without these specific details.

In example embodiments, a smart photography booth is disclosed. A customer selects merchandise such as clothing and jewelry to view in the booth. The merchandise may be pre-identified, or identified as the customer enters the booth. For example, the merchandise may be scanned in by a shop clerk. The customer is photographed with the merchandise. The identification of the merchandise is used to aid in identifying the merchandise in the photograph. In example embodiments, the customer is offered a copy of the photograph in either digital or paper form, for example. In another example, the customer is offered an electronic link to the photograph which can be sent to the customer by email or text to the customer, for example. The offer of a copy of or link to the photograph may be given in exchange for identification from the customer of certain personal details such as the customer's email address or shopping preferences, for example. Other details or information are possible. In some examples, a photograph taken in the smart booth (or sent via a link) includes supplementary information or further links added to associated sites for purchasing the merchandise or sharing the photograph.

In order to comply with applicable data privacy laws or other laws, the customer can be asked for consent to use the photograph for commercial purposes such as for advertising the merchandise. Conveniently, the smart photography booth can provide consistent professional lighting and/or quality. In some examples, the smart photography booth tracks any merchandise that was photographed in the booth and match the merchandise with the identification of the customer.

In another example embodiment, the smart photography booth can provide information regarding customer interest or preferences in merchandise to interested parties such as shops, wholesalers, manufacturers, and advertisers. In an example embodiment, the smart photography booth aids customer identification of merchandise in a photograph by identifying (or pre-identifying) the merchandise to be photographed or using other information regarding the merchandise to aid in identifying the merchandise.

In further example embodiment, the smart photography booth can provide photographs of merchandise for promotional purposes with or without associated identification information of customers. In one application, the smart photography system can reduce theft from a shop by creating a list of items that a customer is trying on in the booth for security cross-check purposes.

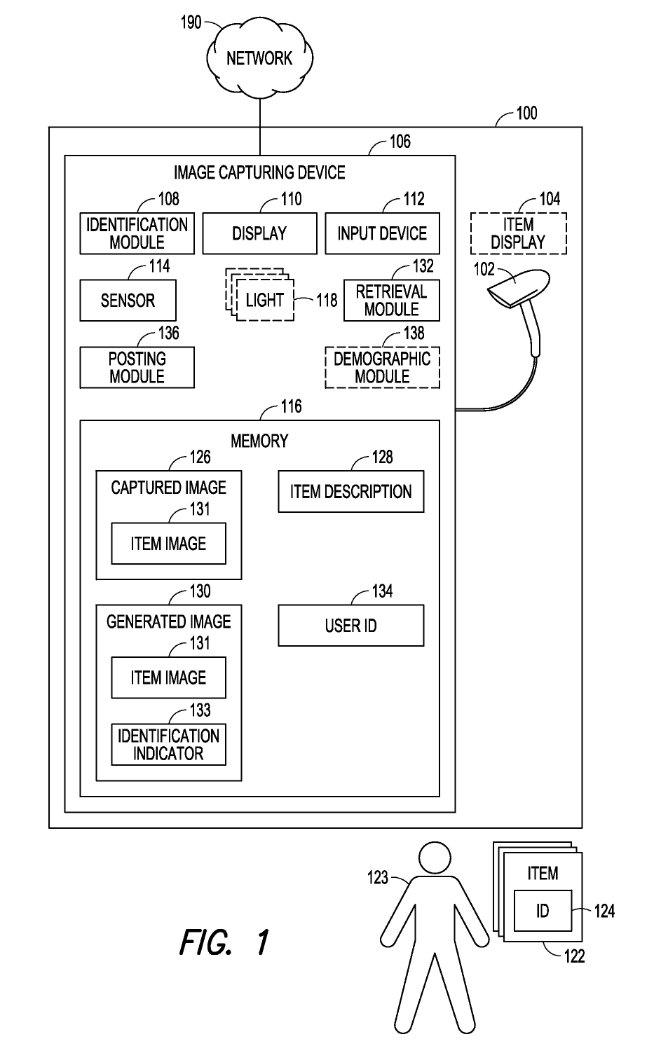

FIG. 1 is a block diagram of smart photography system 100, according to example embodiments. Illustrated in this view are a smart photography system 100, items 122, user 123, and network 190.

In example embodiments, the smart photography system 100 is a system that determines an identification (ID) 124 of an item 122 to retrieve an item description 128 of the item 122, and which generates using the item description 128 a generated image 130 that includes an identification indicator 133 of an item image 131 of the identified item 122. In an example embodiment, the smart photography system 100 may be a photography booth. In an example embodiment, the smart photography system 100 may be a hand-held device.

The item 122 may be an item having an ID 124. For example, items 122 may be merchandise such as clothing, jewelry, watches, and other wearable items.

The ID 124 may be an identification of the item 122. In example embodiments, the ID 124 is one or more of a bar code, a smart tag that wireless transmits the ID 124 of the item 122, or another identifying device or manufacture that may be used to identify the item 122. In an example embodiment the ID 124 may include the item description 128.

The user 123 may be a user of the smart photography system 100. In an example embodiment, the user 123 may be a customer of a shop (not illustrated) selling the item 122.

In example embodiments, the network 190 is a wired or wireless communications network. In example embodiments, the network 190 may be communicatively coupled to the smart photography system 100.

The smart photography system 100 includes optionally, an identification device 102, optionally, an item display 104, and an image capturing device 106.

The identification device 102 may be configured to determine the ID 124 of an item 122. In an example embodiment, the identification device 102 may be a scanner and the ID 124 may be a bar code. In an example embodiment, the identification device 102 may be an antenna that receives ID 124 wirelessly. In example embodiments, the identification device 102 is optional, and the image capturing device 106 determines the ID 124 of the item 122 by capturing an image of the item 122 and/or the ID 124 of the item 122. For example, a sensor 114 may capture an image of a bar code identifying the item 122.

The item display 104 may be a display configured to display ID 124 of an item 122 to assist in identifying the item 122. In example embodiments, the item display 104 includes an interface to assist in identifying the items 122 and/or in listing the items 122. In example embodiments, the item display 104 may be part of the item identifier 102.

The image capturing device 106 may be a device configured to capture images. In example embodiments, the image capturing device 106 includes an identification module 108, a display 110, an input device 112, sensor 114, memory 116, lights 118, retrieval module 132, posting module 136, and demographic module 138. In an example embodiment, the image capturing device 106 may be a camera. The image capturing device 106 may include one or more processors (not illustrated).

The sensor 114 may be a sensor configured to generate a captured image 126 from light reflected from the item 122 and incident to the sensor 114. Example embodiments of the sensor 114 include charge-coupled devices (CCD) and active pixel sensors.

The display 110 may be a display configured to display the captured image 126 and/or generated image 130. In example embodiments, the display 110 may be configured to display one or more user interface displays to a user 123. In example embodiments, the display 110 may be a light emitting diode display or touch sensitive light emitting diode display.

The input device 112 may be a device that enables the user 123 to interact with the image capturing device 106. For example, the input device 112 may be a keyboard and/or mouse. In an example embodiment, the input device 112 may be integrated with the display 110. For example, the input device 112 may be a touch sensitive display. In an example embodiment, the input device 112 may be a camera that captures interaction from the user and interprets the interaction based on the captured images.

The memory 116 may be a memory to store data and/or instructions. The memory 116 may be locally located or located across the network 190. In example embodiments, the memory 116 is partially located locally and partially located remotely. In example embodiments, the memory 116 stores one or more of the identification module 108, the retrieval module 132, posting module 136, and the demographic module 138. The memory 116 may store a captured image 126, item description 128, generated image 130, and user ID 134.

The captured image 126 may be a captured image 126 that includes an item image 131. The item image 131 may be an image of the item 122 captured using the sensor 114. The captured image 126 may include images of more than one item 122 and of one or more users 123.

The generated image 130 may be an image that the image capturing device 106 generated from the captured image 126 and which includes the item image 131 and an identification indicator 133 of the item 122.

The item description 128 may be a description of the item 122. The item description 128 may include information regarding the item 122 such as color, general description, size, material, and so forth.

The user ID 134 may be an identification of a user 123. In example embodiments, the user ID 134 is one or more of a credit card number, email address, customer number, or user name.

The retrieval module 132 may match the ID 124 of the item 122 to an item description 128. The retrieval module 132 may reside in the image capturing device 106 or in the network 190. The retrieval module 132 may determine that the item description 128 is included in the ID 124. The retrieval module 132 may access a database (not illustrated), which may be located over the network 190, to retrieve the item description 128.

The identification module 108 may use the item description 128 to identify the item image 131 in the captured image 126. The identification module 108 may be located in the image capturing device 106. In an example embodiment the identification module 108 may be located in the network 190. For example, the sensor 114 may capture the captured image 126 and may send the captured image 126 to another device in the network. The identification module 108 may be located in the network either on the same device as the captured image 126 or on another device. The identification module 108 may then use the item description 128 to identify the item image 131 in the captured image 126. In an example embodiment, the identification module 108 generates a generated image 130 from the captured image 126. The generated captured image 130 may include an identification indicator 133. The identification indicator 133 indicates the identification of the item 122. In example embodiments, the identification indicator 133 may be an identification added to the generated image 130. In example embodiments, the identification indicator 133 may include a hot link to a website.

The identification module 108 may be configured to compare two or more item descriptions 128 to identify the item image 131 in the captured image 126. For example, the identification device 102 may determine the IDs 124 of three items 122. The item descriptions 128 may then be retrieved for the three items 122. The identification module 108 may then use the item descriptions 128 of the three items 122 to determine the identity of the item image 131. For example, the identification module 108 may compare the item image 131 with the three item descriptions 128 and determine the ID 124 of the item image 131 based on which item description 128 is closest. In example embodiments, the identification module 108 may determine the ID 124 of the item image 131 by eliminating some item descriptions 128 based on the item description 128. For example, the identification module 108 may determine that an item image 131 indicates that the size of an object does not match the size indicated in the item description 128.

In example embodiments, the identification module 108 may have item descriptions 128 of some or all of the items 122 that are likely in the generated image 130. For example, the identification module 108 may have a list of some or all of the item descriptions 128 available in a store and determine the ID 124 of the item image 131 by matching the item image 131 to the closest item description 128. In an example embodiment the identification module 108 may use a kd-tree and may determine the ID 124 of the item 122 based on the item image 131 being closest to an item description 128 based on the different characteristics that may be in the item description 128.

In example embodiments, the identification module 108 may determine the ID 124 of an item image 131 by identifying the ID 124 in the captured image 126. For example, a sweater may have a tag attached and the identification module 108 may determine that the tag is an ID 124 of the sweater based on the proximity of the ID 124, and, in example embodiments, based on information in the item description 128. For example, the identification module 108 may determine that there are several IDs 124 and determine that a portion of the captured image 126 corresponds to one of the IDs 124 based on one or more of the following that may be in the item description 128: color, size, shape, etc. In example embodiments, the identification module 108 modifies the captured image 126 to remove the ID 124 from the generated image 130, and may replace the captured image 126 area of the ID 124 with a generated portion of the generated image 130 by determining what was under the ID 124.

In example embodiments, the identification module 108 may enhance the item image 131. For example, the identification module 108 may make the colors more vibrant in the item image 131 so that the item 122 appears more desirable or so that the item 122 is more easily noticed in the generated image 130.

The lights 118 may provide lighting for reflecting off the item 122 and user 123 to the sensor 114. In example embodiments, the lights 118 are not included. The lights 118 may enable the image capturing device 106 to generate a professional looking generated image 130. In example embodiments, the image capturing device 106 adjusts the direction and/or level of the light from the lights 118.

The posting module 136 may transfer the generated image 130 to the user 123. In example embodiments, the posting module 136 may get the user ID 134 from the user 123 in exchange for transferring the generated image 130 to the user 123. In example embodiments, the posting module 136 may get permission from the user 123 to use the generated image 130 in exchange for transferring the generated image 130 to the user 123.

The demographic module 138 may maintain a database (not illustrated) relating to items 122 and users 123. In example embodiments, the database may be partially or wholly stored across the network 190, and be part of a larger database. For example, a chain of stores may have many smart photography systems 100 and aggregate the data regarding items 122 and users 123. In example embodiments, the demographic module 138 may generate reports regarding the items 122 and user 123.

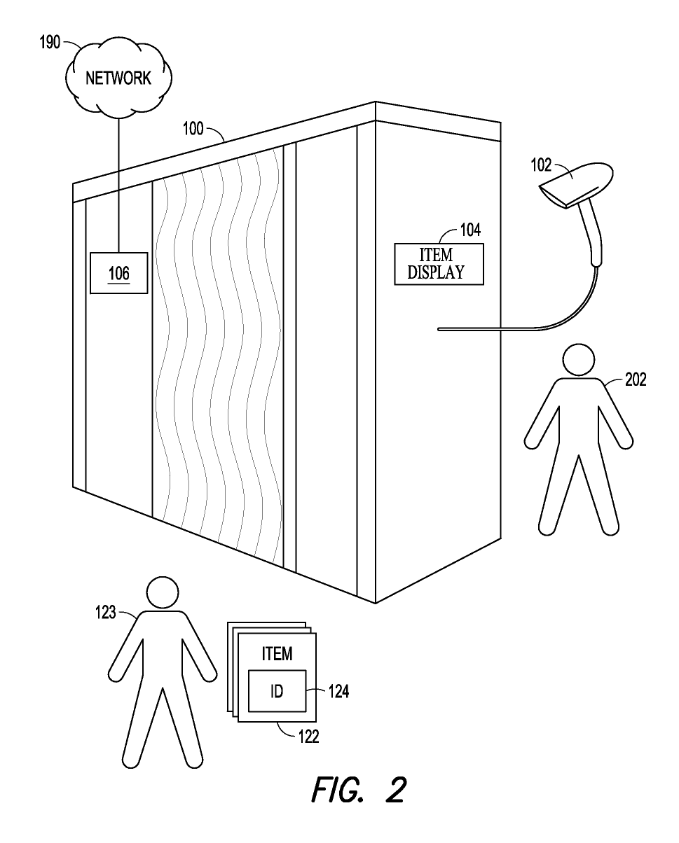

FIG. 2 is an illustration of smart photography system 100 according to example embodiments. Illustrated in FIG. 2 are a smart photography system 100, an identification device 102, an item display 104, an image capturing device 106, items 122, ID 124, user 123, network 190, and person 202.

The smart photography system 100 may be a photo booth in a shop. The person 202 may be shop clerk that may identify the items 122 using the identification device 102 for the user 123. The item display 104 and/or the identification device 102 may be communicatively coupled to the image capturing device 106. The item display 104 and/or the identification device 102 may be communicatively coupled to the image capturing device 106 via the network 190, or, in example embodiments, via a different network such as a local area network or cellular network.

The user 123 may select items 122, which are identified by the identification device 102. The user 123 may step inside the smart photography system 100. The image capturing device 106 may generate a generated image 130 (see FIG. 1). The user 123 may provide a user identification 134 (see FIG. 1) that may be used to send the generated image 130 to the user 123.

The smart photography system 100 may provide the technical advantage of being able to identify items 122 more accurately by using the item description 128 to identify the item image 131 in the captured image.

The smart photography system 100 may provide the technical advantage of better inventory control by having a user 123 identify all the items 122 that the user 123 may try on before the user 123 tries on the items. In example embodiments, the shop may then verify that the user 123 has either returned items 122 or purchased items 122.

The smart photography system 100 may provide the advantage of providing generated images 130 for promotional use with the permission of the user 123 to use the generated images 130 for professional use. The user 123 may want to see how they look in the items 122 before purchasing and the generated image 130 may provide feed-back to the user 123. The user 123 may provide permission to use the generated images 130 in exchange for the generated image 130 being transferred to the user 123.

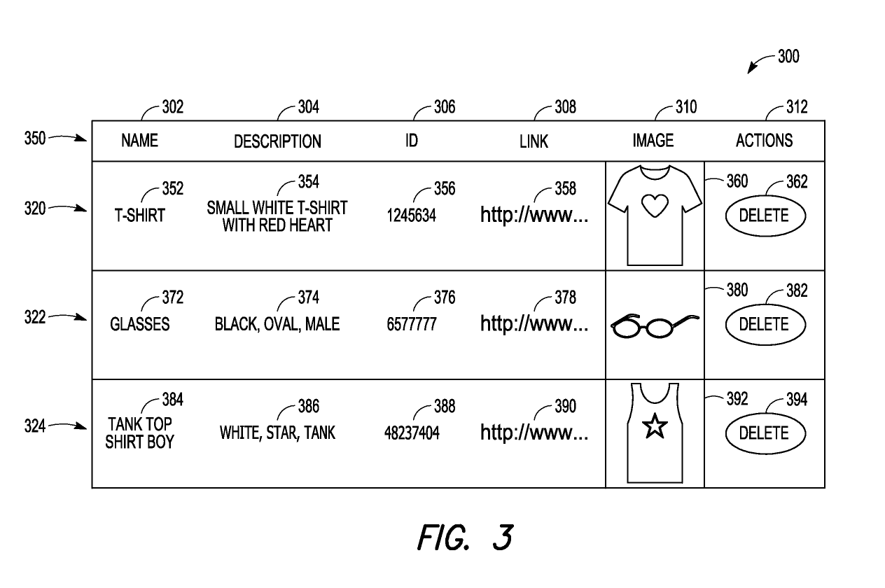

FIG. 3 illustrates an example interface 300 for identifying the items 122 according to an example embodiment. Illustrated in FIG. 3 are headers of columns 350 along the horizontal axis with rows of a first example item 320, second example item 322, and third example item 324. The columns 350 may include name 302, description 304, identification (ID) 306, link 308, image 310, and actions 312. The first item 320 may be a t-shirt 352 with description 354, ID 356, and link 358. The actions 312 may include delete 362, 382, 394 and other appropriate actions such as modify, which may bring up a touch screen to modify one or more of the values of the columns 350. In example embodiments, the ID 124 of the item 122 includes one or more of the headers 350. The retrieval module 132 may use the ID 124 of an item 122 to retrieve an item description 128. The item description 128 may be used to populate the columns 350. In some embodiments, the ID 124 of the item 122 may include the item description 128. For example, the ID 124 may be a smart tag that includes a wireless transmitter that transmits item description 128 to the identification device 102, or, in another example embodiment the item description 128 may be encoded in a bar type of code.

In example embodiments, the example interface 300 assists in assuring that the example items 320, 322, and 324 are identified accurately. Also illustrated is item 322 with name glasses 372, and with a description 374, ID 376, link 378, and image 380. Additionally, item 324 is illustrated with name tank top shirt boy 384, description 386, ID 388, and link 390.

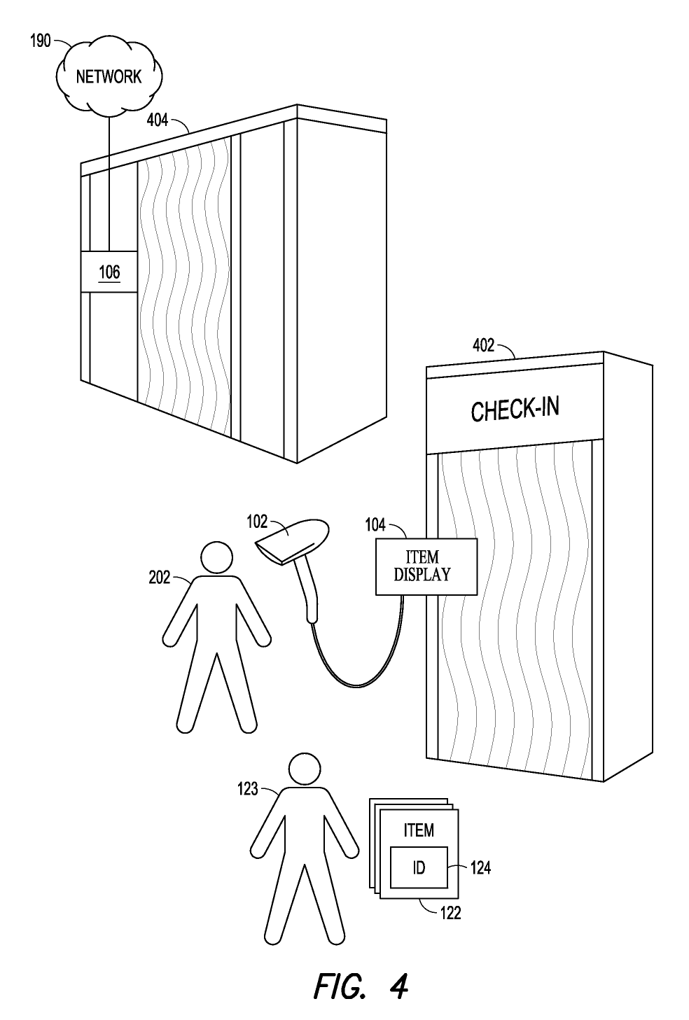

FIG. 4 illustrates an example embodiment for a smart photography system. Illustrated in FIG. 4 are a network 190, smart photography booth 404, check-in station 402, identification device 102, item display 104, image capturing device 106, person 202, user 123, and items 122 with ID 124.

The smart photography booth 404 and check-in station 402 may be communicatively coupled. In example embodiments, the check-in station 402 is separate from the smart photography booth 404. In example embodiments, the check-in station 402 is a changing room. In example embodiments, the check-in station 402 is attached to the network 190, and may communicate with the smart photography booth 404 via the network 190. The check-in station 402 may enable the user 123 to check-in their items at the check-in station 402, and change into the items 122, and then go over to the smart photography booth 404 to have their photograph taken with the items 122. The photography booth 404 may include a device to indicate the identity of the user 123. For example, the user 123 may be given a token with an identification to identify the user 123 and items 122. The user 123 may then scan the token in at the photography booth 404. In this way, the smart photography system 400 may keep track of different users and may identify the items 122 before the items 122 are worn by the user 123. In some embodiments, the user 123 may be given a number such as five at the check-in station 402 and then the number may be used at the photography booth 404 to identify the user 123 and items 122. In some embodiments, the user 123 may give the user ID 134 (FIG. 1) which may be used to identify the user 123 at the photography booth 404.

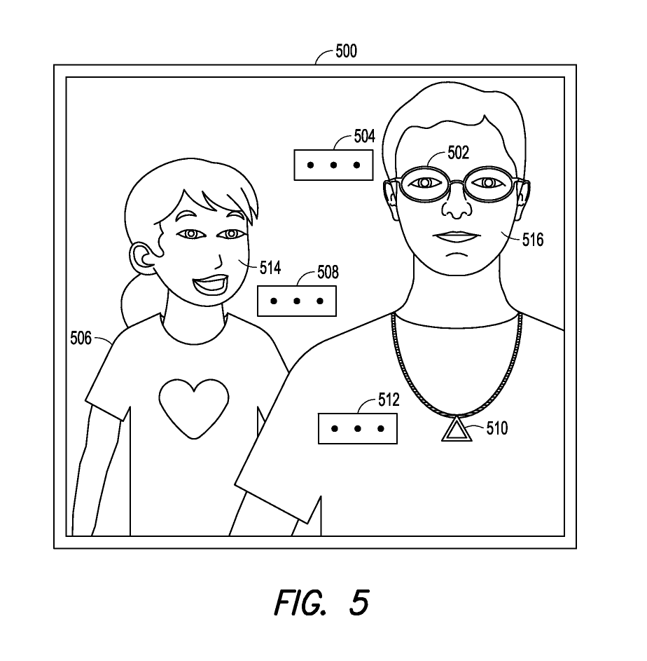

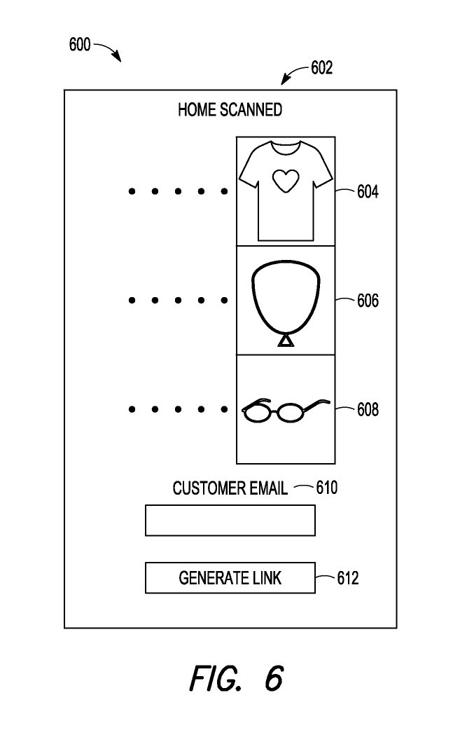

FIG. 5 is an example of a generated image 500, according to example embodiments. Illustrated in FIG. 5 is a first user 516, a second user 514, an image of a first item 506, an image of a second item 502, an image of a third item 510, an identification indicator 508 for the first item 506, an identification indicator 504 for the second item 502, and an identification indicator 512 for the third item 510. The items 506, 502, and 510 may be identified items. For example, the first item 506 may correspond to identified item 604 (see FIG. 6). The second item 502 may correspond to identified item 608. The third identified item 510 may correspond to identified item 606 (see FIG. 6). The identification indicators 504, 508, 512, may be hotlinks to websites that may provide additional information and/or functions for the corresponding item. The identification indicators 504, 508, 512 may include a price, name, and other information related to the corresponding item 506, 502, and 510. In example embodiments, the identification indicators 504, 508, 512 may be hidden. For example, a mouse click on the generated image 500 may make the identification indicators 504, 508, 512 be displayed or not be displayed. The identification module 108 (see FIG. 1) may have generated the generated captured image 500. In example embodiments, the hotlinks may take the user 123 to more generated images 500 of other users 123 wearing the same items 122 or related items 122.

FIG. 6 illustrates an example interface 600 for a user to enter a user identification. Illustrated in FIG. 6 is an example interface 600, a list of scanned items 602, with the list including three items 604, 606, and 608, a field to input an email address 610, and a generate link 612 button to activate sending a link to the generated image 130 or sending the generated image 130. In example embodiments, the interface 600 may be different. For example, in an embodiment speech recognition may be used and the user 123 may say their user identification 134. In example embodiments, a scanner may scan an user identification 134. In example embodiments, the user 123 may transmit the user identification 134 from a wireless device. In example embodiments, rather than an email address 610 for the user identification 134, other information could be used. In example embodiments, the user identification 134 may be used to look-up an email address for the user 123 in a database (not illustrated). For example, the user 123 may be asked for a credit card number, loyalty number, a room number in the case of a hotel, or other information that may be used to identify a place to send a link to the generated captured image 130 or to send the generated captured image 130.

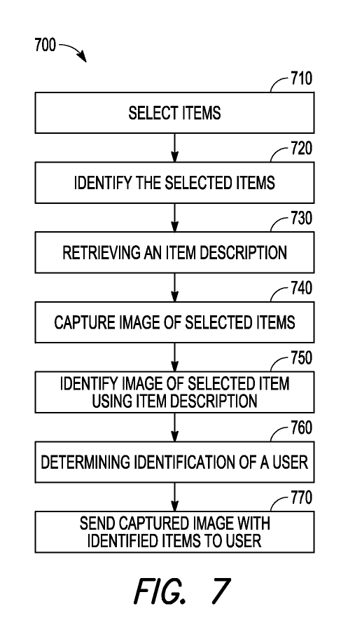

FIG. 7 illustrates a method 700 of a smart photography system according to example embodiments. The method 700 may begin at 710 with selecting items. For example, the user 123 may select one or more items 122 from a shop.

The method 700 may continue at 720 with identifying the selected items. For example, the ID 124 of the items 122 may be determined by the identification device 102. The ID 124 may be a bar code and the identification device 102 may be a scanner. The ID 124 may be stored in the memory 116.

The method 700 may continue at 730 with retrieving an item description 128. For example, the retrieval module 132 may use the ID 124 to determine an item description 128. For example, the image capturing device 106 may include a database (not illustrated) that associates item descriptions 128 with ID 124. In example embodiments, the image capturing device 106 may receive the item description 128 from across the network 190.

The method 700 may continue at 740 with capturing one or more images of the selected items. For example, the user 123 may put the item 122 on and have the sensor 114 generate the capture image 126. In example embodiments, the light 118 provides professional lighting.

The method 700 may continue at 750 with identifying the image of the selected item using an item description. For example, the identification module 108 may use the item description 128 to identify item image 131 in captured image 126 as described herein.

The method 700 may continue at 760 with determining identification of a user. For example, the image capturing device 106 can be configured to request user identification 134 from user 123 using the display 110 and input device 112. In an example embodiment, another input device 112 may be used to request user identification 134. For example, the user 123 may be asked for user identification 134 at check-out. In example embodiments, the posting module 136 determines the identification of the user as disclosed herein.

The method 700 may continue at 770 with sending the captured image with identified items to the user 123. For example, the generated image 130 may be sent to the user 123 using the user identification 134. The method 700 may end. The method 700 steps may be performed in a different order. For example, at 760 determining identification of a user may be performed after the user selects items at 710. Optionally, the identification of the user and the items selected may be stored by the demographic module 136. In example embodiments, the demographic module 138 stores which items the user purchased.

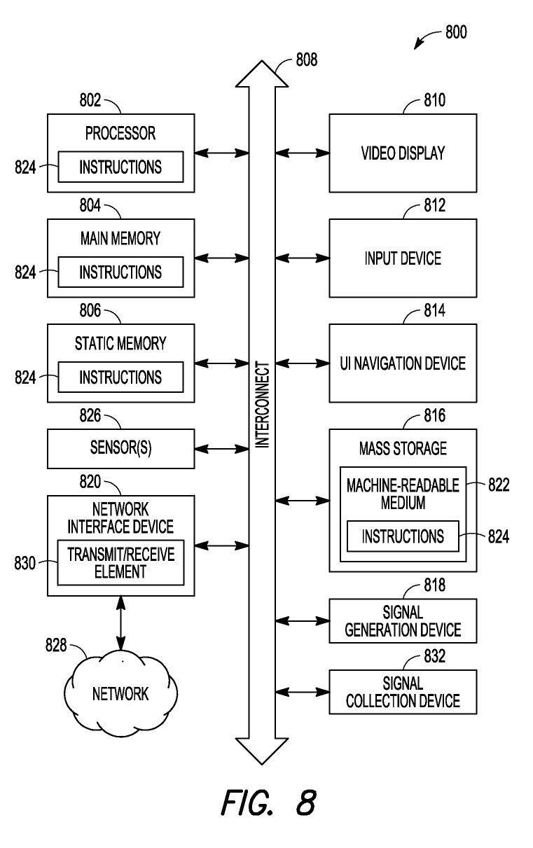

FIG. 8 is a block diagram of a machine or apparatus in the example form of a computer system 800 within which instructions for causing the machine or apparatus to perform any one or more of the methods disclosed herein may be executed and in which one or more of the devices disclosed herein may be embodied. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a wearable device, a tablet PC, a set-top box (STB), a personal digital assistant (PDA), a cellular telephone, a web appliance, a network router, switch or bridge, identification device 102, image capturing device 106, or another machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes one or more processors 802 (e.g., a central processing unit (CPU), a graphics processing unit (GPU), or both), a main memory 804, and a static memory 806, which communicate with each other via a bus 808. In example embodiments, memory 116 may be one or both of main memory 804 and static memory 806. Moreover, memory 116 may be partially stored over network 828.

In example embodiments, the computer system 800 includes a display unit 810 (e.g., a liquid crystal display (LCD) or a cathode ray tube (CRT)). In example embodiments, the computer system 800 also includes an alphanumeric input device 812 (e.g., a keyboard), a user interface (UI) navigation device 814 (e.g., a mouse), mass storage 816, a signal generation device 818 (e.g., a speaker), a network interface device 820, and sensor(s) 826. In example embodiments, the network interface device 820 includes a transmit/receive element 830. In example embodiments, the transmit/receive element 830 is referred to as a transceiver. The transmit/receive element 830 may be configured to transmit signals to, or receive signals from, other systems. In example embodiments, the transmit/receive element 830 may be an antenna configured to transmit and/or receive radio frequency (RF) signals. In an example embodiment, the transmit/receive element 830 may be an emitter/detector configured to transmit and/or receive infrared (IR), ultraviolet (UV), or visible light signals, for example. In an example embodiment, the transmit/receive element 830 may be configured to transmit and receive both RF and light signals. It will be appreciated that the transmit/receive element 830 may be configured to transmit and/or receive any combination of wireless signals.

The mass storage 816 includes a machine-readable medium 822 on which is stored one or more sets of instructions and data structures 824 embodying or used by any one or more of the methods, modules, or functions described herein.

For example, the instructions 824 may include identification module 108, retrieval module 132, posting module 136, and demographic module 138, and/or an implementation of any of the method steps described herein. The instructions 824 may be modules. The instructions 824 may also reside, completely or at least partially, within the main memory 804, static memory 806, and/or within the one or more processors 802 during execution thereof by the computer system 800, with the main memory 804 and the one or more processors 802 also constituting machine-readable media. The instructions 824 may be implemented in a hardware module. In example embodiments, the sensor(s) 826 may sense something external to the computer system 800. For example, the sensor 826 may be a sensor that takes incident light and converts it to electrical signals.

While the machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and compact disk read only memory (CD-ROM) and digital video disc-read only memory (DVD-ROM) disks.

The instructions 824 may further be transmitted or received over a communications network 828 using a transmission medium. The instructions 824 may be transmitted using the network interface device 820 and any one of a number of well-known transfer protocols (e.g., hypertext mark-up protocol (HTTP)). Examples of communication networks include a local area network (LAN), a wide-area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

Thus, a method and system to identify items in a captured image have been described. Although example embodiments have been described with reference to specific example embodiments, it will be evident that various modifications and changes may be made to these embodiments without departing from the broader spirit and scope of the example embodiments. Accordingly, the specification and drawings are to be regarded in an illustrative rather than a restrictive sense.

Example embodiments have the advantage of increasing customer engagement (ex. by using product images by bloggers and everyday customers) and yet providing professional marketing by providing photographs of the products taken by the smart photography system which may provide quality photographs taken with coordinated lighting. Example embodiments, by providing hyperlinks in the photographs and by informing customers of the availability of the photographs, have the advantage of driving interested traffic to online retailer sites in which the customer will likely convert. Example embodiments have the advantage that by providing hyperlink photographs to the customers the customers may make their photographs available to friends or other people and may be more likely to purchase the products.

Example embodiments include a method of a smart photography system. The method may include identifying an identity of an item, and retrieving a description of the item from the identity of the item. The method may include capturing an image including an image of the item, and identifying the image of the item in the captured image using the description of the item. The method may include generating from the captured image a generated image comprising the image of the item and an identification indicator of the image of the item. The method may be performed by a smart photography booth in a retail store. The item may be one of the following group comprising: clothing, jewelry, shoes, glasses, or a wearable consumer item. The method may include associating the item with the identification of the user and storing the association of the item with the identification of the user. The identification of the user associated with the item may be one of the following group: email address, name, customer number, and credit card number.

Example embodiments include a smart photography system. The smart photography system may include a retrieval module comprising one or more processors configured to determine a description of the item from the identity of the item. The smart photography system may include a sensor configured to capture an image including an image of the item. The smart photography system may include an image identification module comprising the one or more processors configured to identify the image of the item in the captured image using the description of the item and configured to generate from the captured image a generated image comprising the image of the item and an identification indicator of the image of the item. Example embodiments include where the smart photography system is further configured to determine an identity of an item.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A smart photography system, the smart photography system comprising:
an identification device configured to determine an identity of an item;
a retrieval module comprising one or more processors configured to determine a description of the item from the identity of the item;
a sensor configured to capture an image including an image of the item; and
an image identification module comprising the one or more processors configured to identify the image of the item in the captured image using the description of the item and configured to generate from the captured image a generated image comprising the image of the item and an identification indicator of the image of the item.

2. The smart photography system of claim 1, wherein the identification device is further configured to determine an identity of one or more other items, and the retrieval module is further configured to determine a description of the one or more other items from the identification of the one or more other items; and
wherein the image identification module is further configured to identify the image of the item in the captured image using the description of the item and the description of the one or more other items based on determining which description the item is closest to.

3. The smart photography system of claim 1, wherein the identification device is at least one of the following group: a scanner and a wireless receiver configured to receive a wireless signal identifying the item from a device associated with the item.

4. The smart photography system of claim 1, further comprising a display and an input device, wherein the input device is configured to receive an identification of a user associated with the item.

5. The smart photography system of claim 4, wherein the identification of the user associated with the item is at least one of the following group: an email address, a name, a customer number, and a credit card number.

6. The smart photography system of claim 5, wherein the smart photography system is further configured to offer to send the generated image in exchange for the identification of the user.

7. The smart photography system of claim 5, wherein the smart photography system is further configured to offer to send the generated image in exchange for the user agreeing to permit use of the generated image.

8. The smart photography system of claim 5, further comprising a demographic module comprising the one or more processors configured to associate the item with the identification of the user and store the association of the item with the identification of the user.

9. The smart photography system of claim 1, further comprising a posting module comprising the one or more processors configured to send a link to the generated image to the user.

10. The smart photography system of claim 1, wherein the system is a smart photography booth in a retail store.

11. The smart photography booth of claim 1, wherein the item is one of the following group comprising: clothing, jewelry, shoes, glasses, or a wearable consumer item.

12. The smart photography system of claim 1, wherein the identification module is further configured to generate the generated image with a clickable link to a webpage for the item.

13. A method of a smart photography system, the method comprising:
identifying an identity of an item;
retrieving a description of the item from the identity of the item;
capturing an image including an image of the item;
identifying the image of the item in the captured image using the description of the item; and
generating from the captured image a generated image comprising the image of the item and an identification indicator of the image of the item.

14. The method of claim 13, wherein the identifying the identity of the item is performed by one of the following group: a scanner and a wireless receiver configured to receive a wireless signal identifying the item from a device associated with the item.

15. The method of claim 13, further comprising:
receiving an identification of a user associated with the item.

16. The method of claim 15, further comprising:
sending the generated image to the user in exchange for the identification of the user.

17. The method of claim 15, further comprising:
offering to send the generated image to the user in exchange for user consent to permit use of the generated image.

18. The method of claim 13, further comprising:
sending a link to the generated image to the user.

19. The method of claim 13, further comprising:
generating the generated image with a clickable link to a webpage for the item.

20. A non-transitory computer-readable storage medium including instructions that, when executed by one or more processors, cause the processors to:
identify an identity of an item;
retrieve a description of the item from the identity of the item;
capture an image including an image of the item;
identify the image of the item in the captured image using the description of the item; and
generate from the captured image a generated image comprising the image of the item and an identification indicator of the image of the item.
